(19) United States
(12) Patent Application Publication
(10) Pub. No.: US 2018/0278721 A1
(43) Pub. Date: Sep. 27, 2018

(54) Techniques and Architectures for Providing a Command Line Interface Functionality as a Web Service

(71) Applicant: salesforce.com, inc., San Francisco, CA (US)

(72) Inventor: Christopher Wall, Austin, TX (US)

(21) Appl. No.: 15/466,752

(22) Filed: Mar. 22, 2017

(51) Int. Cl. H04L 29/08

(52) U.S. Cl. CPC H04L 67/36; H04L 67/02

(57) ABSTRACT

Techniques and mechanisms to provide command line interface (CLI) tools as a service. A service platform receives a command request for an application development function via an application program interface (API). The request is in the form of a command line interface (CLI) command from a development environment. The service platform provides functionality corresponding to the command request for code designated by the development environment. The code is updated based on the functionality. The updated code is stored in a data storage device. An indication to the computing platform that the functionality has been performed by the service platform is provided.

### TECHNICAL FIELD

Embodiments relate to techniques for providing command line interface (CLI) tools as a set of services accessible by, for example, a graphical user interface. More particularly, embodiments relate to techniques for providing command line interface (CLI) tools as a set of web-based services accessible, for example, to support a cloud-based app.

### BACKGROUND

As services and functionality moves to more cloud based architectures to replace local (e.g., mobile device, desktop) based applications, increased support for development is desirable. Current development tools tend to be command line interface (CLI)-based for various reasons. These CLI-based development tools are typically controlled through, and executed by, a computer being used to develop the code. This traditional approach can be unnecessarily limiting and/or inefficient.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of an architecture in which development tools can be provided as a service.

FIG. 2 is a block diagram of one embodiment of an architecture illustrating cloud based development tools.

FIG. 3 illustrates a block diagram of an environment where an on-demand database service might be used.

FIG. 4 illustrates a block diagram of an environment where an on-demand database service might be used.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

Described herein are techniques and architectures to provide development tools (toolkit or toolbelt) as a service (TaaS). This approach can allow a version control mechanism (or database environment) to be a source of truth for apps rather than the organization (within a multitenant environment) being the source of truth. In one embodiment, these development tools are provided as a service where well-defined application program interfaces (APIs) are utilized to use the tools. In one embodiment, each tool can be a command line interface (CLI) based operation and have a corresponding name and, for example, a POST or GET operate to invoke the command.

In one embodiment, two types of CLI commands are supported: general commands & app commands. General commands operate on a platform (e.g., Heroku) account as a whole, and are not specific to a particular app. For instance, to get a list of apps created by one or more specified developers. App commands are typically executed from within an app's local working copy. In one embodiment, the app name is automatically detected by scanning version control files (e.g., Git remotes) for the current working copy, so the app is not stated explicitly. For example, the “heroku apps:info” command can be executed without any arguments inside the working copy.

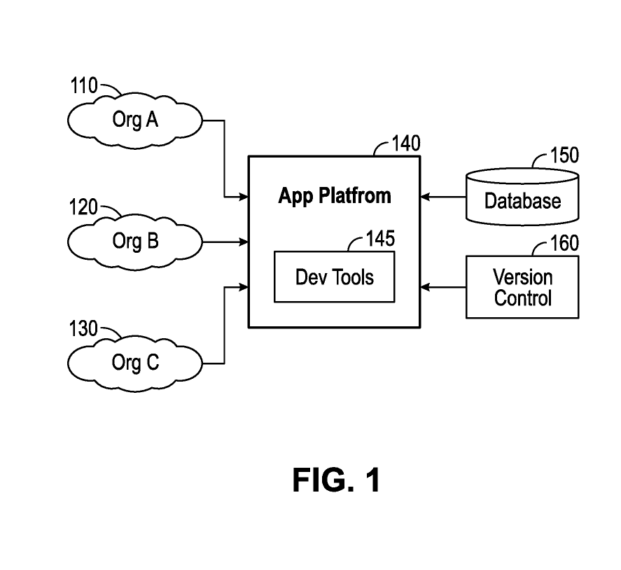

FIG. 1 is a block diagram of one embodiment of an architecture in which development tools can be provided as a service. The example of FIG. 1 includes just three organizations/tenants/customers (orgs) within the overall architecture; however, any number of orgs can be supported.

In the architecture of FIG. 1, app platform 140 is a platform-as-a-service (PaaS) that can function as a web application (or app) deployment mechanism. Various programming languages can be supported so that developers can build, run and scale apps across multiple languages. App platform 140 can be, for example, a Heroku-based environment; however, other implementations can also be supported to provide the techniques and services described herein.

In one embodiment, development (dev) tools 145 provide the functionality described herein as a service to entities utilizing app platform 140. Because dev tools 145 provide a set of tools that can be used to develop, deploy, debug and/or otherwise support apps provided by app platform 140, dev tools 145 can be conceptually thought of as a virtual toolbelt. As these tools are provided as a service, this can be described as a toolbelt as a service (TaaS).

In one embodiment, version control entity 160 operates to manage versions of code that app platform 140 uses to provide apps to one or more orgs (e.g., org 110, org 120, org 130). Database 150 can be utilized to store data and/or code for the apps provided through app platform 140.

In various embodiments, one or more apps can be developed for app platform 140 using dev tools 145. Using more traditional techniques, development tools are utilized via a CLI. However, as described herein, dev tools 145 can be utilized via API and provided by app platform 140.

In one embodiment, each tool provided by dev tools 145 can be a CLI-based operation that has a corresponding name and, for example, a POST or GET operate to invoke the command. Names and descriptions of various example embodiments are provided in greater detail below. By providing dev tools 145 as a service, various commands can be invoked from remote orgs (e.g., org 110, org 120, org 130) and can be performed by app platform 140 using code acquired from version control entity 160.

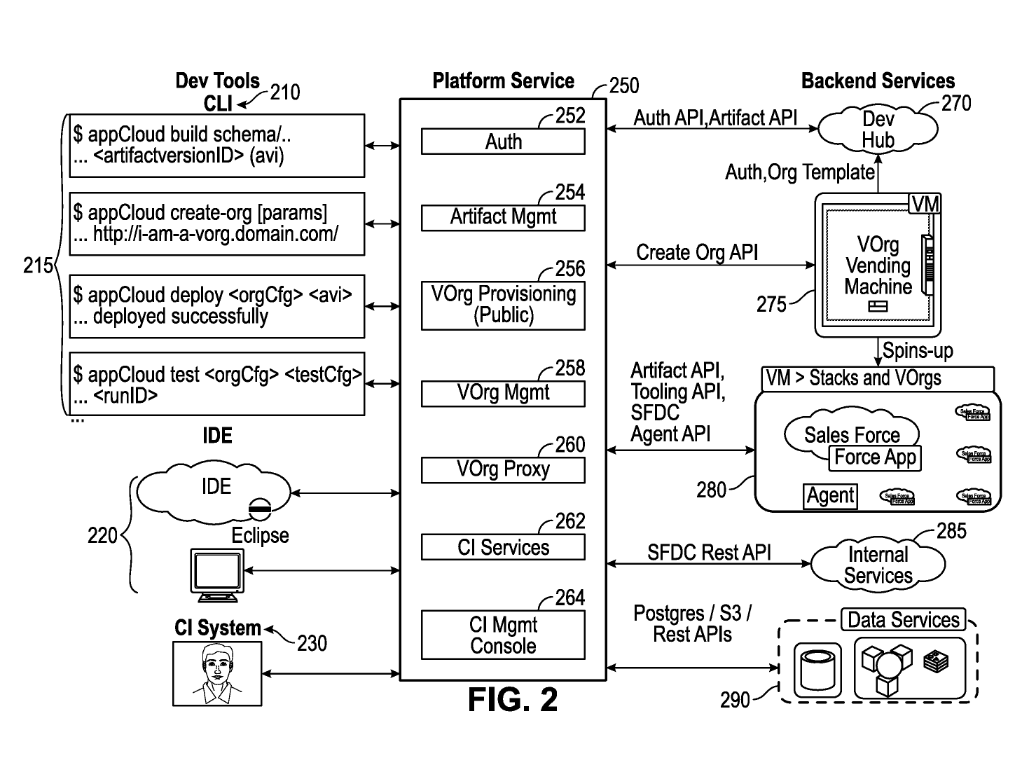

FIG. 2 is a block diagram of one embodiment of an architecture illustrating cloud based development tools. In the example of FIG. 2, command line interface (CLI) tools 210 through which one or more users can issue one or more commands 215 that can be invoked interacting via web services to services in one or more cloud-based on-demand environments. Various embodiments of on-demand environments (including multitenant embodiments) are described in greater detail below.

In one embodiment, an integrated development environment (IDE) 220 can be provided. IDE 220 can be, for example, Eclipse, which is available as part of the Salesforce environment. In one embodiment, continuous integration (CI) 230 can also be provided.

In one embodiment, service platform 250 provides services for one or more of CLI tools 210, IDE 220 and/or CI systems 230. The example of FIG. 2 illustrates a few of the services provided by service platform 250. In alternate embodiments, additional and/or different services can be provided.

In one embodiment, service platform 250 provides authorization service agent 252 and artifact management service agent 254. Various functionalities that can be provided by authorization service agent 252 and artifact management service agent 254 are described in greater detail below. In one embodiment, service platform 250 provides virtual organization (VOrg) services including, for example, VOrg provisioning agent 256, VOrg management agent 258, and VOrg proxy agent 260. Various functionalities that can be provided for VOrg support are described in greater detail below.

In one embodiment, service platform 250 provides continuous integration services with CI services agent 262 and/or CI management console 264. Other and/or different services can be provided by service platform 250.

In one embodiment, service platform 250 provides services, at least in part, by utilizing one or more back end services. These backend services can include, for example, development hub 270 that can provide, for example, authentication and/or artifact services and/or related functionality. In one embodiment, VOrg vending machine 275 provides virtual org services and/or functionality.

In one embodiment, one or more virtual orgs can be deployed in multitenant cloud environment 280. Service platform 250 can also provide the services described herein for and with orgs within multitenant cloud environment 280. Various embodiments of an architecture that can be utilized to provide multitenant cloud environment 280 are described in greater detail below.

In one embodiment, internal services 285 can provide functionality corresponding to one or more services provided by service platform 250. Data services 290 can provide one or data stores and corresponding functionality to support services provided by service platform 250.

In various embodiments one or more of the following commands can be supported. In other embodiments, different groups of commands including commands not listed can be provided in the manner described herein.

In one embodiment, an authorization command is provided. The authorization command can be used, for example, to authorize an organization/tenant/customer for usage within a project workspace. One example use case for this command is to authorize an environment hub. This gives developers the ability to create their own workspace “Scratch Orgs.” In some embodiments, project workspaces require there to be at least one “hubOrg” configured for development purposes.

In one embodiment, a create org command is provided. The create org command can be used, for example, to create new workspace organization/tenants/customers. A workspace org can be used, for example, for bidirectional synchronization of source code. For example, when a developer creates a new workspace org, validation can occur to ensure the existing org does not have unsynchronized changes. Once the changes are resolved a new workspace org can then be created. The old abandoned org can be used as a test org or could be deleted.

In one embodiment, a delete org command is provided. The delete org command can be used, for example, to marks an organization/tenant/customer for deletion. After the org is marked it can be removed from the environment hub and local file system records. In one embodiment, once an org is marked for deleted it cannot be recovered.

In one embodiment, a list orgs command is provided. The list org command can be used, for example, to list all organizations/tenants/customers currently authorized and/or created by a user on a development machine. This includes all scratch org types.

In one embodiment, a status command is provided. The status command can be used, for example, to provide a mechanism to show the changed state of the local workspace or workspace org. The user experience could be similar to, for example, that of Git status. In one embodiment, if a metadata item that has changed in both the local workspace and the workspace org conflict indication can be generated.

In one embodiment, a push metadata source command is provided. The push metadata source command can be used, for example, to synchronize metadata between organizations/tenants/customers, environments, etc. In one embodiment, a pull metadata source command is provided. The pull metadata source command can be used, for example, to make metadata changes in the organization/tenant/customer the user has the option to pull the changes down to the local project workspace. In one embodiment, the user can elect to make further modification locally with the IDE of choice and push back to the org or commit to source control.

In one embodiment, a set org password command is provided. The set org password command can be used, for example, to set, reset, change or otherwise manage one or more passwords corresponding to an organization/tenant/customer.

In one embodiment, an open org command is provided. The open org command can be used, for example, to cause a browser to open an org (e.g., a scratch org). In one embodiment, a run APEX test command is provided. The run APEX test command can be used, for example, to invoke test procedures. In one embodiment, a get test results command is provided. The get test results command can be used, for example, to retrieve and report test results. In one embodiment, an invoke test runner command is provided. The invoke test runner command can be used, for example, to run any type of test against one or more organizations/tenants/customers, tear down the orgs and store the results.

In one embodiment, a test runner config help command is provided. The test runner config help command can be used, for example, to initialize, write and/or validate commands.

In one embodiment, a create package version command is provided. The create package version command can be used, for example, to create a new package version. In one embodiment, an install package version command is provided. The install package version command can be used, for example, to install a package version into a target org.

In one embodiment, a create artifact definition command is provided. The create artifact definition command can be used, for example, to create a new artifact definition. In one embodiment, an update artifact definition command is provided. The update artifact definition command can be used, for example, to update an existing artifact definition. In one embodiment, a list artifact definition command is provided. The list artifact definition command can be used, for example, to list all existing artifact definitions.

In one embodiment, a create artifact version definition command is provided. The create artifact version definition command can be used, for example, to create a new artifact version definition. In one embodiment, an install artifact version command is provided. The install artifact version command can be used, for example, to install an artifact version into a target org.

In one embodiment, a data import command is provided. The data import command can be used, for example, to import data in various formats (e.g., parent-child tree formatted files). In one embodiment, a metadata API retrieve command is provided. The metadata API retrieve command can be used, for example, to retrieve file (e.g., XML) representations of components in an organization/tenant/customer. In one embodiment, a metadata API deploy command is provided. The metadata API deploy command can be used, for example, to deploy file (e.g., XML) representations of components in an org by creating, updating and/or deleting the corresponding components.

In one embodiment, a governor limits command is provided. The governor limit command can be used, for example, to create display maximum execution governor limits for an org. In one embodiment, a log command is provided. The log command can be used, for example, to acquire one or more log IDs and/or debug logs. In one embodiment, an API limit command is provided. The API limit command can be used, for example, to display remaining and maximum calls and events for an org.

In one embodiment, a database query command is provided. The database query command can be used, for example, to query data using a database query language (e.g., SOQL). In one embodiment, a record create command is provided. The record create command can be used, for example, to create a new record and can include assigning values to one or more fields.

In one embodiment, a record update command is provided. The record update command can be used, for example, to update a record and can include assigning and/or updating values to one or more fields. In one embodiment, a record delete command is provided. The record delete command can be used, for example, to delete a record. In one embodiment, a record retrieve command is provided. The record retrieve command can be used, for example, to retrieve a record.

In one embodiment, an object describe command is provided. The object describe command can be used, for example, to acquire metadata describing an object (e.g., a custom object). In one embodiment, a create schema command is provided. The create schema command can be used, for example, to create a custom object with custom fields or to create one or more custom fields on a standard object. In one embodiment, a delete schema command is provided. The delete schema command can be used, for example, to delete a custom object with custom fields or to delete one or more custom fields on a standard object.

In one embodiment, a bulk insert command is provided. The bulk insert command can be used, for example, to create one or more batch jobs for inserting new rows and/or updating existing rows. In one embodiment, a single batch can include multiple jobs. In one embodiment, a bulk status command is provided. The bulk status command can be used, for example, to determine the status of a batch job. In one embodiment, a bulk delete command is provided. The bulk delete command can be used, for example, to delete one or more rows using a batch job.

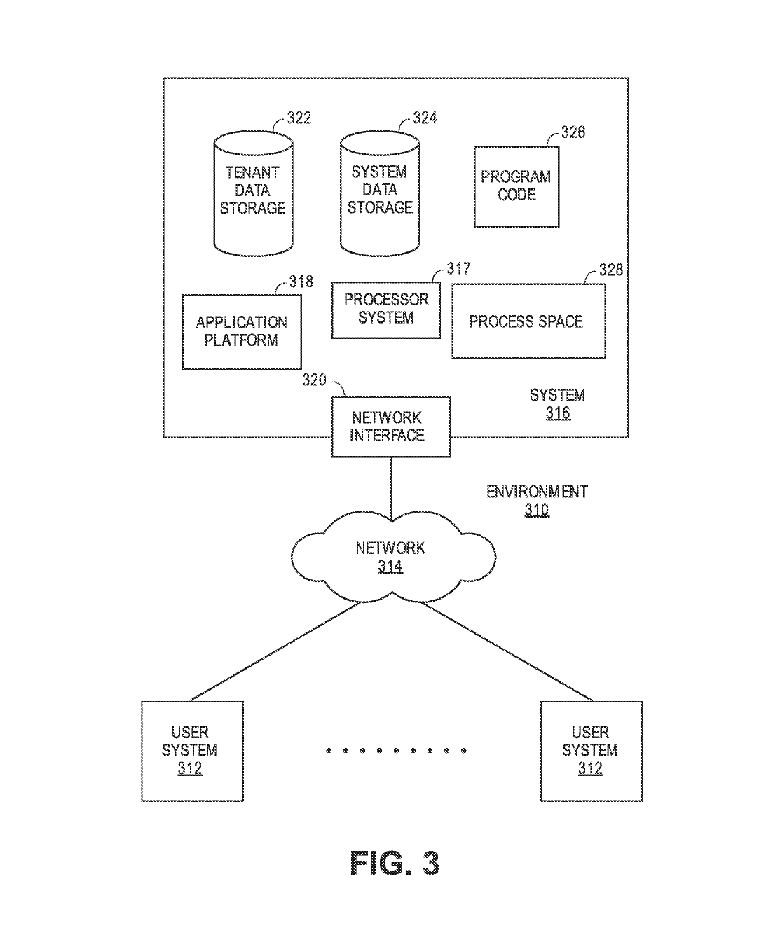

FIG. 3 illustrates a block diagram of an environment 310 wherein an on-demand database service might be used. Environment 310 may include user systems 312, network 314, system 316, processor system 317, application platform 318, network interface 320, tenant data storage 322, system data storage 324, program code 326, and process space 328. In other embodiments, environment 310 may not have all of the components listed and/or may have other elements instead of, or in addition to, those listed above.

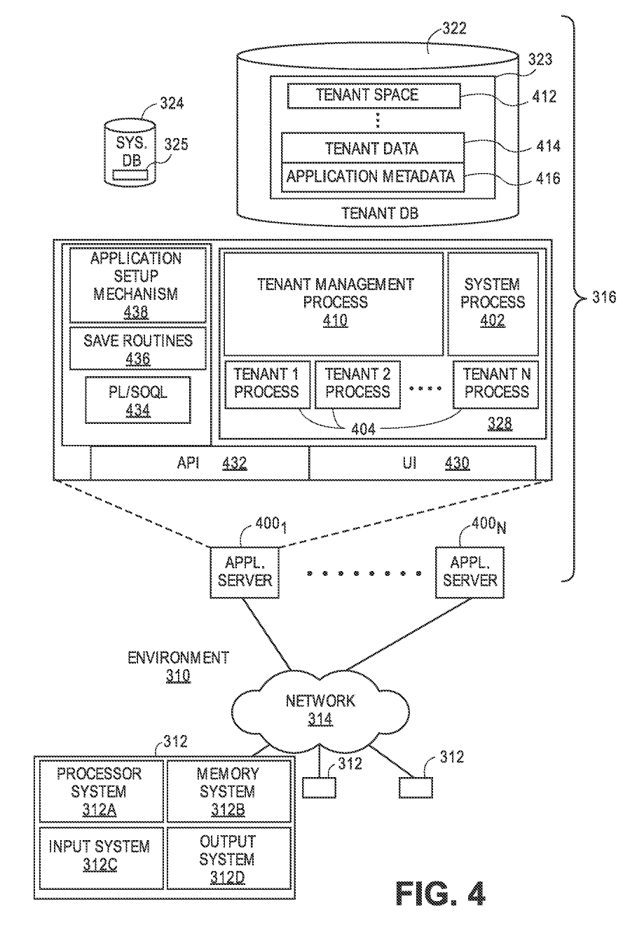

Environment 310 is an environment in which an on-demand database service exists. User system 312 may be any machine or system that is used by a user to access a database user system. For example, any of user systems 312 can be a handheld computing device, a mobile phone, a laptop computer, a work station, and/or a network of computing devices. As illustrated in herein FIG. 3 (and in more detail in FIG. 4) user systems 312 might interact via a network 314 with an on-demand database service, which is system 316.

An on-demand database service, such as system 316, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 316” and “system 316” will be used interchangeably herein. A database image may include one or more database objects. A relational database management system (RDMS) or the equivalent may execute storage and retrieval of information against the database object(s). Application platform 318 may be a framework that allows the applications of system 316 to run, such as the hardware and/or software, e.g., the operating system. In an embodiment, on-demand database service 316 may include an application platform 318 that enables creation, managing and executing one or more applications developed by the provider of the on-demand database service, users accessing the on-demand database service via user systems 312, or third party application developers accessing the on-demand database service via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a LAN (local area network), WAN (wide area network), telephone network, wireless network, point-to-point network, star network, token ring network, hub network, or another appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 312 might communicate with system 316 using TCP/IP and, at a higher network level, use other common Internet protocols to communicate, such as HTTP, FTP, AFS, WAP, etc. In an example where HTTP is used, user system 312 might include an HTTP client commonly referred to as a “browser” for sending and receiving HTTP messages to and from an HTTP server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as provide related data, code, forms, webpages and other information to and from user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 316 implements applications other than, or in addition to, a CRM application. For example, system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MTS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Edge from Microsoft, Safari from Apple, Chrome from Google, or a WAP-enabled browser in the case of a cell phone, PDA or other wireless device, or the like, allowing a user (e.g., subscriber of the multi-tenant database system) of user system 312 to access, process and view information, pages and applications available to it from system 316 over network 314. Each user system 312 also typically includes one or more user interface devices, such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 316 or other systems or servers. For example, the user interface device can be used to access data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Core series processor or the like. Similarly, system 316 (and additional instances of an MTS, where more than one is present) and all of their components might be operator configurable using application(s) including computer code to run using a central processing unit such as processor system 317, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates environment 310. However, in FIG. 4 elements of system 316 and various interconnections in an embodiment are further illustrated. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, User Interface (UI) 430, Application Program Interface (API) 432, PL/SOQL 434, save routines 436, application setup mechanism 438, applications servers 400₁-400_{N}, system process space 402, tenant process spaces 404, tenant management process space 410, tenant storage area 412, user storage 414, and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3. Regarding user system 312, processor system 312A may be any combination of one or more processors. Memory system 312B may be any combination of one or more memory devices, short term, and/or long term memory. Input system 312C may be any combination of input devices, such as one or more keyboards, mice, trackballs, scanners, cameras, and/or interfaces to networks. Output system 312D may be any combination of output devices, such as one or more monitors, printers, and/or interfaces to networks. As shown by FIG. 4, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage areas 412, which can be either a physical arrangement and/or a logical arrangement of data. Within each tenant storage area 412, user storage 414 and application metadata 416 might be similarly allocated for each user. For example, a copy of a user's most recently used (MRU) items might be stored to user storage 414. Similarly, a copy of MRU items for an entire organization that is a tenant might be stored to tenant storage area 412. A UI 430 provides a user interface and an API 432 provides an application programmer interface to system 316 resident processes to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410 for example. Invocations to such applications may be coded using PL/SOQL 434 that provides a programming language style interface extension to API 432. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 416 for the subscriber making the invocation and executing the metadata as an application in a virtual machine.

Each application server 400 may be communicably coupled to database systems, e.g., having access to system data 325 and tenant data 323, via a different network connection. For example, one application server 400₁ might be coupled via the network 314 (e.g., the Internet), another application server 400_{N-1} might be coupled via a direct network link, and another application server 400_{N} might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 BIG-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles storage of, and access to, different objects, data and applications across disparate users and organizations.

As an example of storage, one tenant might be a company that employs a sales force where each salesperson uses system 316 to manage their sales process. Thus, a user might maintain contact data, leads data, customer follow-up data, performance data, goals and progress data, etc., all applicable to that user's personal sales process (e.g., in tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

In certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more SQL statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving, via an application program interface (API) with a service platform executing on one or more hardware processing devices coupled with a physical memory device, a command request for an application development function, wherein the request is in the form of a command line interface (CLI) from a development environment provided by a computing platform;
providing, with the service platform, functionality corresponding to the command request for code designated by the development environment;
updating the code based on the functionality;
storing the updated code in a data storage device; and
providing an indication to the computing platform that the functionality has been performed by the service platform.

2. The method of claim 1 wherein the command comprises a general command that operates on the code within a platform account and is not specific to a particular app.

3. The method of claim 1 wherein the command comprises an app command that is executed on the code from within an app's local working copy.

4. The method of claim 1 wherein an app name corresponding to the code is detected by scanning one or more version control files.

5. The method of claim 1 wherein the command comprises a CLI-based operation that has a corresponding name and a POST operation is used to invoke the command.

6. The method of claim 1 wherein the command comprises a CLI-based operation that has a corresponding name and a GET operation is used to invoke the command.

7. A non-transitory computer-readable medium having stored thereon instructions that, when executed by one or more processors, are configurable to cause the one or more processors to:
receive, via an application program interface (API) with a service platform executing on one or more hardware processing devices coupled with a physical memory device, a command request for an application development function, wherein the request is in the form of a command line interface (CLI) from a development environment provided by a computing platform;
provide, with the service platform, functionality corresponding to the command request for code designated by the development environment;
update the code based on the functionality;
store the updated code in a data storage device; and
provide an indication to the computing platform that the functionality has been performed by the service platform.

8. The non-transitory computer-readable medium of claim 7 wherein the command comprises a general command that operates on the code within a platform account and is not specific to a particular app.

9. The non-transitory computer-readable medium of claim 7 wherein the command comprises an app command that is executed on the code from within an app's local working copy.

10. The non-transitory computer-readable medium of claim 7 wherein an app name corresponding to the code is detected by scanning one or more version control files.

11. The non-transitory computer-readable medium of claim 7 wherein the command comprises a CLI-based operation that has a corresponding name and a POST operation is used to invoke the command.

12. The non-transitory computer-readable medium of claim 7 wherein the command comprises a CLI-based operation that has a corresponding name and a GET operation is used to invoke the command.

13. A system comprising:
a memory device;
one or more hardware processing devices coupled with the memory device configurable to receive, via an application program interface (API) with a service platform executing on one or more hardware processing devices coupled with a physical memory device, a command request for an application development function, wherein the request is in the form of a command line interface (CLI) from a development environment provided by a computing platform, to provide, with the service platform, functionality corresponding to the command request for code designated by the development environment, to update the code based on the functionality, to store the updated code in a data storage device, and to provide an indication to the computing platform that the functionality has been performed by the service platform.

14. The system of claim 13 wherein the command comprises a general command that operates on the code within a platform account and is not specific to a particular app.

15. The system of claim 13 wherein the command comprises an app command that is executed on the code from within an app's local working copy.

16. The system of claim 13 wherein an app name corresponding to the code is detected by scanning one or more version control files.

17. The system of claim 13 wherein the command comprises a CLI-based operation that has a corresponding name and a POST operation is used to invoke the command.

18. The system of claim 13 wherein the command comprises a CLI-based operation that has a corresponding name and a GET operation is used to invoke the command.
